(19) United States
(12) Patent Application Publication
(10) Pub. No.: US 2010/0024740 A1
(43) Pub. Date: Feb. 4, 2010

(54) Remotely Operable User Controlled Pet Entertainment Device

(76) Inventor: Ryan Grepper, Portland, OR (US)

Correspondence Address: BOYLE FREDRICKSON S.C., 840 North Plankinton Avenue, MILWAUKEE, WI, 53203, US

(21) Appl. No.: 12/394,020

(22) Filed: Feb. 26, 2009

Related U.S. Application Data
(60) Provisional application No. 61/067,241, filed on Feb. 26, 2008.

(51) Int. Cl. A01K 29/00

(52) U.S. Cl. 119/707

(57) ABSTRACT

A pet entertainment device that is also capable of exercising a pet, such as a cat, via user interaction with the device using a remote control that enables user control of motion of a pet plaything/attractant in or along two degrees of freedom. The device includes a base that rests on a floor that carries a housing rotatable relative thereto enabling corresponding plaything/attractant movement in response to a first user manipulable control of the remote. The housing includes a plaything/attractant carrier, such as a wand, that is movable relative to the housing, the base, and the floor in response to a second user manipulable control of the remote. The device includes a housing rotation drive and a wand drive connected to an electrical power supply and onboard controller that receives wireless control signals from the user-manipulable remote control and carries out user-initiated movement commands inputted into the remote.

### CROSS REFERENCE

This application claims priority under 35 U.S.C. §119(e) to U.S. Provisional Patent Application No. 61/067,241, filed Feb. 26, 2008, the entirety of which is hereby expressly incorporated by reference herein.

### FIELD

The present invention relates to a pet entertainment device and more particularly to a remotely operable user controlled pet entertainment device that is also capable of exercising a pet interacting with the device.

### BACKGROUND

There have been many varieties of pet entertainment devices over the years. Some even physically stimulate the pet enough to provide significant exercise. This can be particularly beneficial for domestic cats as it is not unusual for them to be overweight due to overeating or lack of activity.

Many of these devices are simple cat toys that are placed on the ground with the hope that the cat will interact on its own and begin playing with the toy. While these types of toys have been somewhat successful in causing a cat to interact, they offer virtually no interaction between the pet owner or user and the cat. Other devices are handheld by a user and typically have a long wand with a plaything or attractant attached to the end of the wand. The user manipulates the wand by manually moving it back and forth to entice the cat into interacting with the plaything or attractant. The main problem with these types of cat toys is that they tend to be tiring to the user as they often require the user to stand or sit in an uncomfortable position.

Still other devices are motorized having a plaything or attractant equipped wand that is rotated by the motor around a generally central vertical axis in a manner that seeks to entice the cat into interaction with the plaything or attractant. In addition to not involving the user, many times the repetitive nature of the motion of the wand causes a cat to lose interest after only a short period of operation.

Finally, there is at least one such device intended for cats that is remote controlled and equipped with wheels, enabling a user to steer device along the floor, much like a remote controlled car is driven, in an effort to help entice a cat into interacting with it. The device also has a vertically extending wand that automatically waves around in a random fashion without user control or user interaction. One drawback with this type of remote controlled driven cat toy device is that the level of control is limited as user interaction is only limited to driving the device around on the floor. Another drawback is that this device employs a relatively complicated electrically powered drive train that is susceptible to failure even after a relatively short period of operation. For example, a cat seeking to interact with the toy as it is traveling along the floor can intentionally or inadvertently pounce on the toy. Such repeated contact, hastens wear and tear which can lead to premature failure.

What is needed is a pet entertainment device that is fun and engaging for both the pet and the user. What is also needed is such an entertainment device that provides an increased level of user interaction and control while also capable of exercising the pet.

### SUMMARY

The present invention is directed to a pet entertainment device that is particularly well suited for use with domestic cats that includes a base disposed on a support surface, such as the floor, and that carries a body movable relative thereto with the body carrying a pet plaything or attractant that extends outside the body. Operation of the pet entertainment device is remotely controllable by a user using a remote control. Operation of the pet entertainment device advantageously entices the pet into interaction in a manner that can provide pet exercise.

In a preferred embodiment, the base remains stationary on the floor with the body of the pet entertainment device being rotatively coupled to the base enabling relative rotation therebetween in response to user input using the remote control. The body includes a housing that encloses an onboard drive assembly that includes a first drive arrangement enabling relative rotation between the body and the base and a second drive arrangement in operable cooperation with the pet plaything or attractant enabling movement of the pet plaything or attractant relative to at least one of the base and body.

In a preferred embodiment, the first drive arrangement is carried by the body and includes a first electric motor having an output shaft that operably cooperates with a roller or wheel disposed in contact with the base such that operation of the motor rotates the wheel causing relative rotation between the body and the base. In one preferred embodiment, the output shaft of the first electric motor is coupled by a drive shaft to the roller or wheel.

The housing is configured to permit an elongate, rod-shaped wand carrying the pet plaything or attractant to extend therefrom in a manner that permits relative movement therebetween. In a preferred embodiment, the housing has an elongate slot formed therein through which the wand outwardly extends. The wand is received in an outwardly extending arm of a wand holder gear that cooperates with a drive gear that is driven by an output shaft of a second electric motor of the second drive arrangement.

The housing is attached to a bottom plate that carries the first and second drive arrangements with the housing and bottom plate forming an enclosure that encloses the first and second drive arrangements. There is an onboard electric power supply, such as in the form of batteries held in a battery holder, which supplies power to an onboard controller that receives wireless control signals from the remote control used to control operation of the first and second drive arrangements. The controller is electrically connected to the first electric motor and the second electric motor enabling each motor to be selectively powered by the controller in response to control signals received from the remote control.

In a preferred embodiment, the remote control has a first user manipulable control used to send wireless control signals to the controller to cause relative rotation between the body and the base and has a second user manipulable control used to send wireless control signals to the controller to cause movement of the pet plaything or attractant relative to at least one of the body and the base. User manipulation of the first and second controls of the remote permits substantially simultaneous body rotation and pet plaything or attractant movement. User manipulation of the first and second controls of the remote enables control of body rotation independently of pet plaything or attractant movement.

In a preferred method of operation, two degrees of freedom of pet plaything or attractant movement is possible with the pet plaything or attractant being movable in a first direction when the body is rotated relative to the base and movable in a second direction when the pet plaything or attractant is moved relative to at least one of the body and the base. In a preferred method of operation, movement in the first direction is about a first axis that is generally perpendicular relative to the body and the base and movement in the second direction is about a second axis that is generally transverse relative thereto.

Numerous other aspects, features and advantages of the present invention will be made apparent from the following detailed description taken together with the below-described accompanying drawing figures.

### DRAWING DESCRIPTION

One or more preferred exemplary embodiments of the invention are illustrated in the accompanying drawings in which like reference numerals represent like parts throughout and in which:

FIG. 1 is a perspective view of a user interactive remote controlled pet entertainment device constructed in accordance with the present invention;

FIGS. 2A-2D are side elevation views of the pet entertainment device of FIG. 1 depicting its use with different pet playthings or attractants;

FIG. 3 is a top front perspective view of the pet entertainment device;

FIG. 4 is a rear top perspective view of the pet entertainment device;

FIG. 5 is a front elevation view of the pet entertainment device;

FIG. 6 is a rear elevation view of the pet entertainment device;

FIG. 7 is a top plan view of the pet entertainment device;

FIG. 8 is a right side elevation view of the pet entertainment device;

FIG. 9 is a left side elevation view of the pet entertainment device;

FIG. 10 is a bottom plan view of the pet entertainment device;

FIG. 11 is a top perspective view of the entertainment device with a battery cover partially exploded therefrom showing battery access;

FIG. 12 is an exploded perspective view of the pet entertainment device;

FIG. 13 is a side cross sectional view taken along line 13-13 of FIG. 1 illustrating a housing rotation drive arrangement of the pet entertainment device;

FIG. 14 is a top view of the interior of the pet entertainment device taken along line 14-14 of FIG. 13 with the cover removed; and

FIG. 15 is fragmentary perspective view of a section of the pet entertainment device taken along line 15-15 of FIG. 14 illustrating a portion of a wand drive arrangement.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

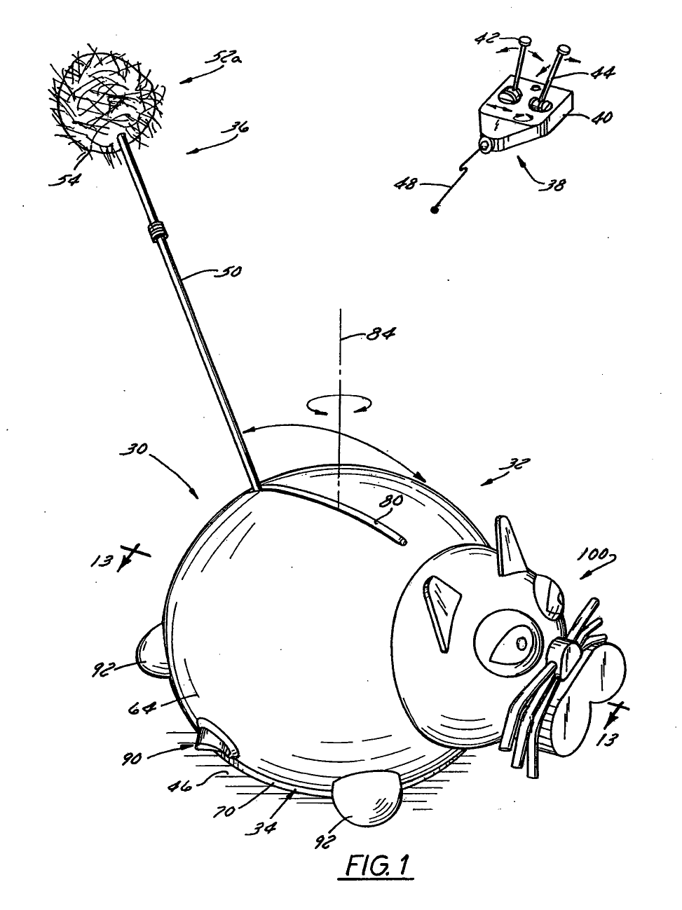

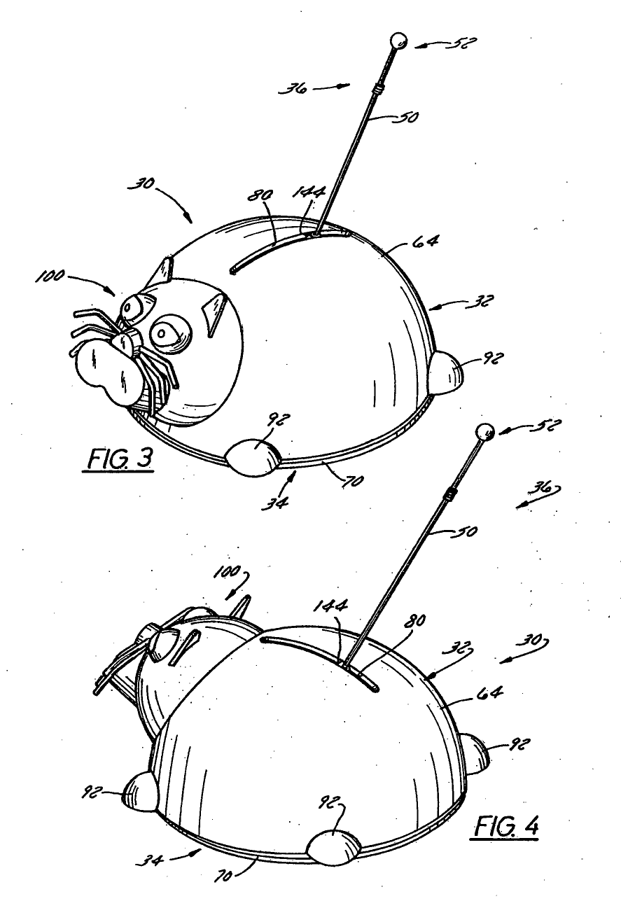

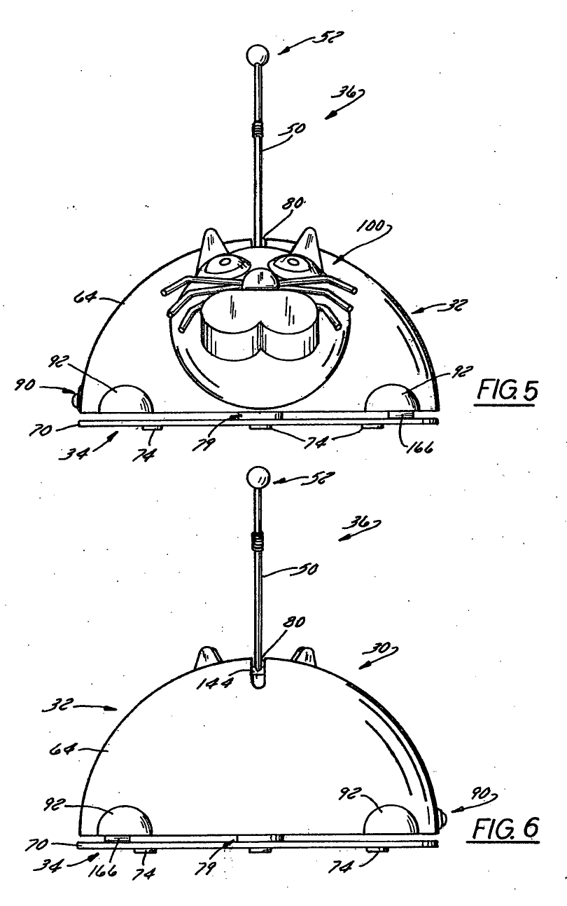

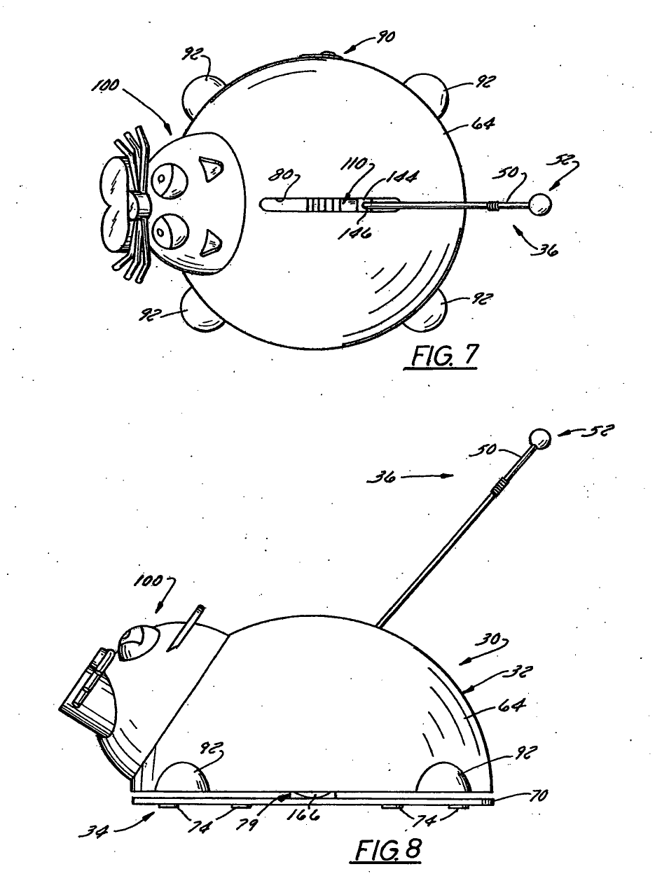

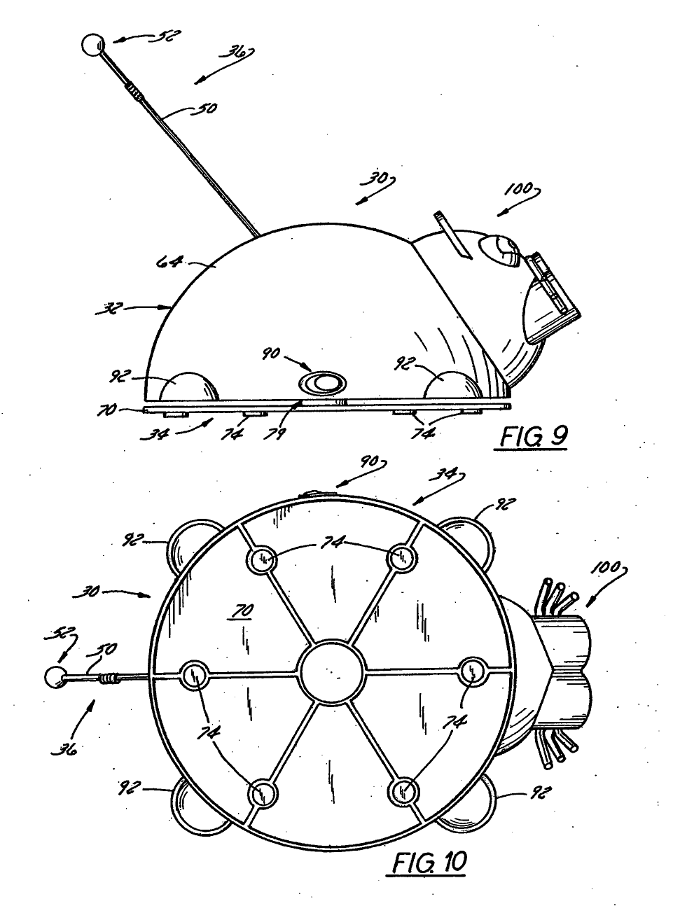

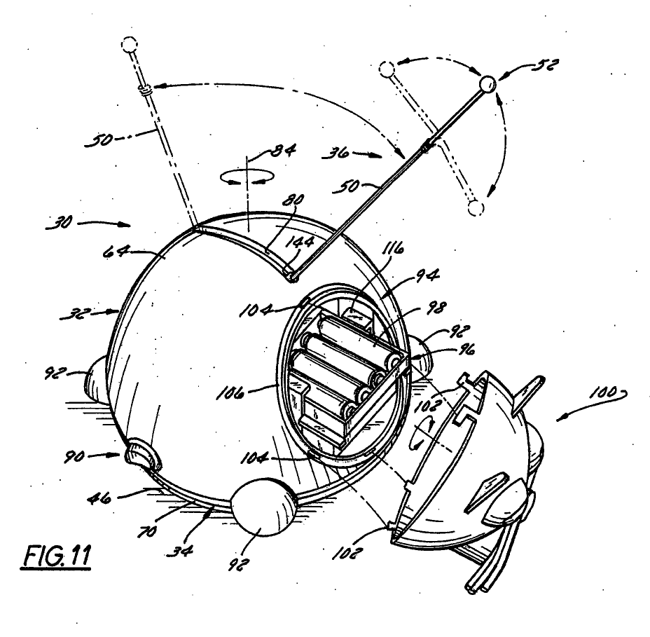

FIGS. 1-15 illustrate a preferred embodiment of a pet entertainment device 30 that includes a body 32, which can be aesthetically configured in a manner that is appealing or attractive to a pet, that is carried by a base 34 in a manner permitting relative movement therebetween and which has a pet plaything or attractant arrangement 36 that is movable relative to the body 32. The pet entertainment device 30 is remotely operable by a user through the use of a remote 38 in a manner that enables the user to control movement of the body 32 as well as movement of the pet plaything or attractant arrangement 36. Such a pet entertainment device 30 is particularly well-suited for use with cats and is particularly well-suited for engaging cats in exercise activity beneficial to their well-being.

The remote 38 is a handheld remote control device 40 that includes a plurality of manipulable controls 42, 44, each of which permits a user control over movement of a particular component of the pet entertainment device 30. In the remote 38 shown in FIG. 1, one of the controls 42 controls back and forth movement of the pet plaything or attractant arrangement 36 and the other one of the controls 44 controls relative rotational movement of the body 32 relative to a support surface 46, such as the floor, upon which the pet entertainment device 30 rests or is otherwise supported. In the preferred embodiment of the remote 38 shown in FIG. 1, each control 42, 44 is a manipulable joystick.

However, if desired, other suitable controls, such as buttons, or other control arrangements can be employed to enable user-controlled relative rotational movement of the body 32 and user controlled movement of the pet plaything or attractant arrangement 36. As should also be apparent from the remote control arrangement depicted in FIG. 1, user control of the relative rotational movement of the body 32 is independent of user control of the movement of the pet plaything or attractant arrangement 36.

As is also depicted by the remote control arrangement shown in FIG. 1, the remote control device 40 wirelessly communicates with the pet entertainment device 30. In a preferred embodiment, the remote control device 40 wirelessly communicates with the pet entertainment device 30 via a radio frequency link. As such, the remote control device 40 can be equipped with an antenna that is an external antenna 48, such as is shown in FIG. 1, but which also can be internal if desired. In a preferred embodiment, the remote control device 40 enables remote control of the pet entertainment device 30 from a distance of at least four feet away from the pet entertainment device 30 and includes an onboard radio or transceiver. Such a remote control device 40 is electrically powered, such as via electrical supplied from one or more onboard batteries that can be of rechargeable construction.

The pet plaything or attractant arrangement 36 includes a connector, preferably a wand 50, movably coupled to the body 32 of the pet entertainment device 30 with the wand 50 having a pet plaything or attractant 52a carried by the wand 50. In the preferred embodiment shown in FIG. 1, the pet plaything or attractant 52a is a ball 54 of furry or fluffy construction that is attached to the wand 50 at or adjacent its free end. As is depicted in FIG. 11, such a wand 50 can be of flexible construction thereby enabling bending during movement to further entice a pet into interaction with the plaything or attractant 52a.

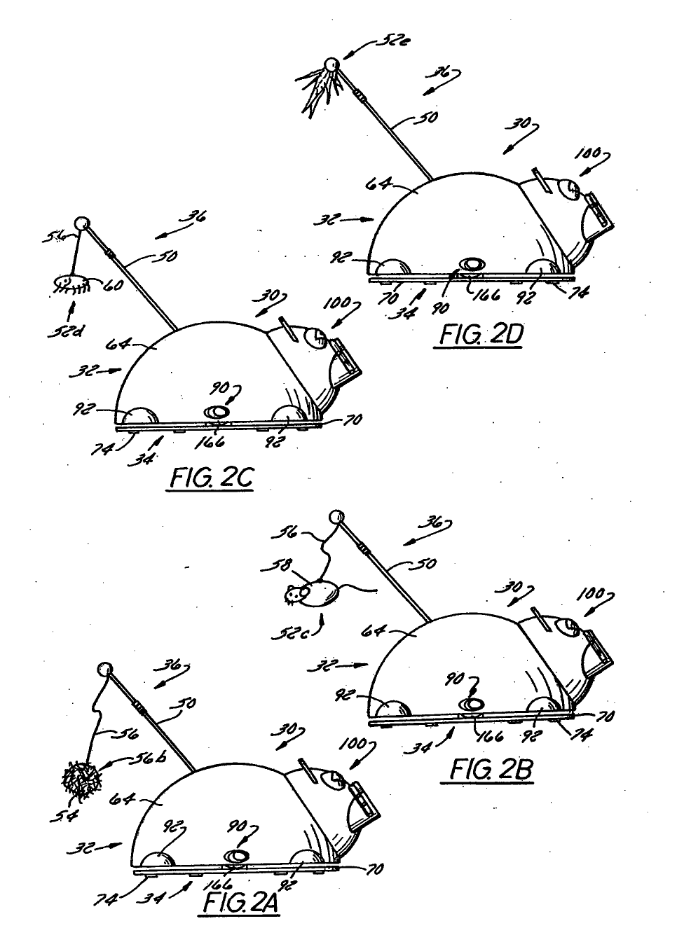

Other pet plaything or attractant arrangements are contemplated as being within the scope of the present invention. For example, FIG. 2A illustrates a pet plaything or attractant 52b where the furry or fluffy ball 54 is attached to the wand 50 by a flexible line 56 that can be a string, constructed of fishing line or the like. FIG. 2B illustrates a pet plaything or attractant 52c that is a mouse 58 attached to the wand 50 by line 56. FIG. 2C illustrates another embodiment of a pet plaything or attractant 52d that is a spider-like toy 60 attached to the wand 50 by line 56. FIG. 2D illustrates still another embodiment of a pet plaything or attractant 52e that is a feather toy 62. Such a feather toy 62 can also be attached to the wand 50 using a flexible line 56 or the like. The terms “pet plaything” and “pet attractant” are used interchangeably herein such that “pet plaything” will only be used subsequently herein.

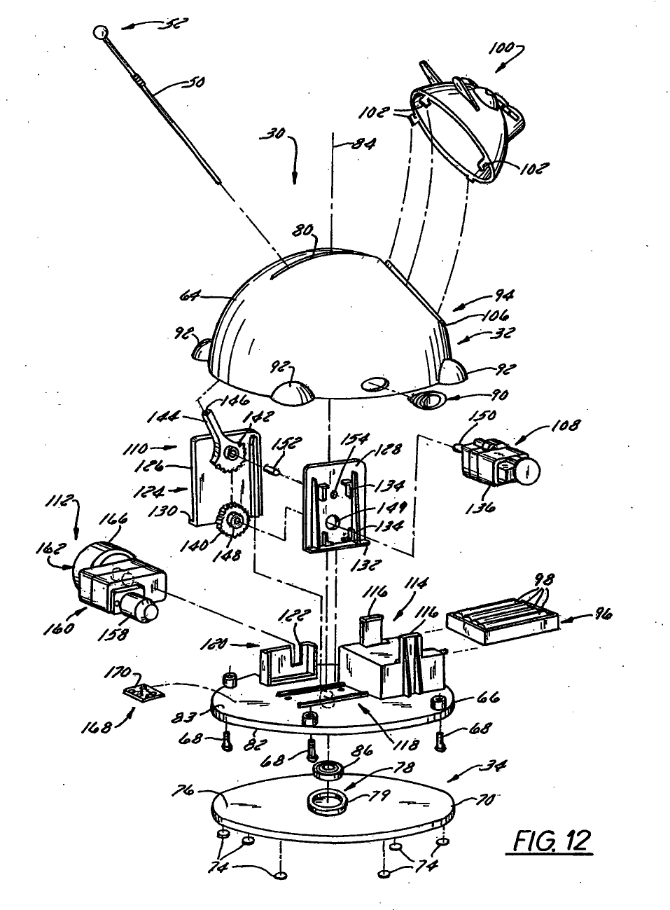

The pet entertainment device body 32 includes a housing 64 that attaches to a bottom plate 66 via fasteners 68 (FIG. 12) with the bottom plate 66 being rotatable relative to a base plate 70 of the base 34. The base plate 70 rotatively carries the bottom plate 66 in a manner permitting the bottom plate 66, and hence the entire body 32 of the pet entertainment device 30, to rotate relative to the base plate 70. The base plate 70 is configured to remain stationary upon floor 46 such that the body 32 is not only rotatable relative to the base plate 70, but is therefore also rotatable relative to the floor 46. To enable the base plate 70 to remain stationary during operation of the pet entertainment device 30, the bottom surface 72 of the base plate 70 is equipped with a plurality of pads 74 or the like spaced circumferentially adjacent to and radially inboard of the outer periphery of the base plate 70. Such pads 74 can be composed of rubber or another suitably frictionally engaging material that helps keep the base plate 70 from sliding along the floor 46 or otherwise rotating relative to the floor 46.

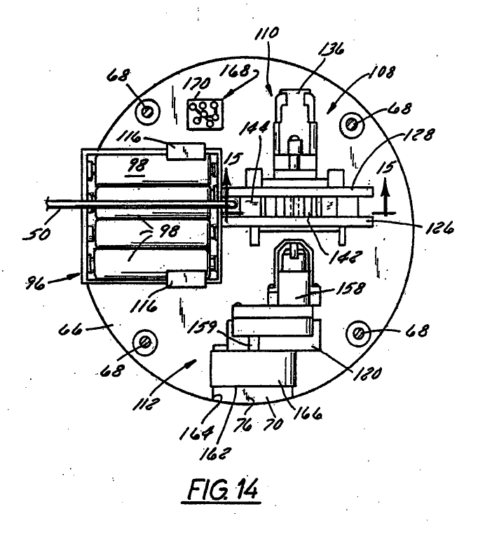

With specific reference to FIGS. 12 and 14, the base plate 70 has a top surface 76 from which a generally centrally disposed upraised and annular pivot receiver 78 upwardly extends. As is best shown in FIG. 12, the pivot receiver 78 is an upraised annular flange 79 integrally formed of the base plate 70. The body bottom plate 66 has a circular or generally cylindrical pivot 88 that extends downwardly from its bottom surface 82 and is receivable in the pivot receiver 78 formed in the top surface 76 of the base plate 70 thereby enabling the body bottom plate 66 to rotate relative to the base plate 70 about a generally centrally located axis of rotation 84. Such a pivot 88 preferably is integrally formed of the body bottom plate 66.

It should be recognized that the pivot 88 can also be formed in the base plate 70 with the pivot receiver 78 being formed in the body bottom plate 66. If desired, an annular bearing 86 or the like can be disposed in the pivot receiver 78 to facilitate rotation of the body bottom plate 66 by minimizing friction caused by relative rotation between the pivot 88 and the pivot receiver 78. In at least one preferred embodiment, no such bearing 86 is employed.

If desired, the body bottom plate 66 can be rotatively coupled to the base plate 70 in another manner, including in a manner that attaches the body 32 to the base 34. Such attachment can be releasable in nature if desired. In one preferred embodiment, the pivot receiver 78 and pivot 88 couple, such as via snap-fit engagement or the like, in a manner that prevents the body bottom plate 66 from being separated from the base plate 70 while permitting relative rotation therebetween. For example, in one embodiment, the pivot 88 can be constructed to extend through a bore (not shown) formed in the pivot receiver 78 with the pivot 88 having a radially outwardly extending flange or tab that engages the base plate 70 in a manner that prevents the plates 66, 70 from separating.

The housing 64 of the body 32 of the pet entertainment device 30 is generally rounded in shape. In the preferred embodiment shown in the drawing figures, housing 64 is substantially hemispherical thereby advantageously helping deflect and/or absorb the momentum or impact of a pet, such as a cat, pouncing upon it during interaction with the pet entertainment device 30. A switch 90, such as electrical on-off switch, is mounted to the housing 64 in a manner that permits the pet entertainment device 30 to be easily turned on or off.

The housing 64 has an elongate slot 80 formed in it that enables the wand 52 extends through it and into the interior of the body 32. The slot 80 has a length sufficient to permit the wand 52 to move back and forth over an arc that encompasses an angle, α, of at least 45°. In a preferred embodiment, the slot 80 formed in the housing 64 has a length sufficient to permit wand movement to encompass an angle, α, of at least 80° when moved from its maximum extent in one direction to its maximum extent in an opposite direction.

The pet entertainment device 30 can also include a plurality of outrigger-like feet 92, configured to appear as animal feet or the like, which extend outwardly therefrom adjacent the base 34 to help enhance stability by preventing tipping and/or sliding of the device 30 in response to an animal, e.g. domestic cat, impacting against the housing 64 during pet interaction with the device. In a preferred embodiment, such outwardly extending feet 92 are integrally formed of the housing 64 and are spaced substantially equal angularly about the circumference or periphery thereof. In another embodiment, such feet 92 are aesthetic in nature, such as being designed to mimic the appearance of feet of an animal as depicted in the drawing figures.

As is best shown in, FIGS. 11-13, the housing 64 also includes an access opening 94 formed in it that permits access to the interior of the body 32. In the preferred embodiment shown in the drawing figures, the access opening 94 is located to provide convenient access to a battery holder 96 that carries a plurality of batteries 98, e.g., AA batteries, used to supply electrical power to the pet entertainment device 30. The access opening 94 enables convenient and easy replacement of batteries 98 in the battery holder 96. In one preferred embodiment, the access opening 94 is sized large enough to permit removal and return of the battery holder 96.

Overlying the access opening 94 is a cover 100 that releasably engages the housing 64 in a manner that enables quick and easy removal of the cover 100. As is best shown in FIG. 11, the cover 100 has a plurality of outwardly extending hooks 102 that each are received in a corresponding aperture 104 formed in a flanged cover-engaging collar region 106 encompassing the periphery of the access opening 94 enabling the cover 100 to be twisted in one direction to releasably attach the cover 100 to the housing 64 and to be twisted in an opposite direction to disengage the cover 100 from the housing 64. Such a removable cover 100 is formed so as to extend outwardly from the housing 64 in a manner that enables a user to easily grasp and rotate the cover 100. In the preferred embodiment shown in the drawing figures, the removable cover 100 is aesthetically configured to have an appearance that mimics the head or face of an animal.

With reference to FIGS. 12-15, the housing 64 and body bottom plate 66 collectively form an enclosure in which a drive assembly 108 that includes a wand drive arrangement 110 and a housing rotation drive arrangement 112 disposed with the bottom plate 66 serving as a drive carriage therefor. A top surface 83 of the bottom plate 66 has an upraised battery holder receiving pedestal 114 having a plurality of battery holder engaging fingers 116 that clip the battery holder 96 in place in a manner that allows it and the batteries 98 in the holder to withstand rotational acceleration encountered during rotation of the housing 64 during pet entertainment device operation.

With specific reference to FIG. 12, the top surface 83 of the bottom plate 66 also includes an integrally formed drive assembly seat 118 that brackets or frames the axis of rotation 84 such that the drive assembly 108 is generally located adjacent the axis of rotation 84 helping to minimize the magnitude of moments created during housing rotation and wand movement. By locating the drive assembly 108 generally adjacent the axis of rotation 84, forces acting on the pet entertainment device 30 resulting from moments created during housing rotation and/or wand movement, which can occur simultaneously, are minimized. In addition, the drive assembly seat 118 locates the components of the drive assembly adjacent the top surface 83 of the bottom plate 66 thereby lowering the center of gravity of the pet entertainment device 30, all of which advantageously helps to increase stability of the device 30 during operation.

Located adjacent the drive assembly seat 118 is an integrally formed housing rotation drive support 120 that locates and supports the housing rotation drive arrangement. In the preferred embodiment shown, the support 120 is an upraised bracket integrally formed of the bottom plate 66 that locates and supports part of the housing rotation drive arrangement 112. The housing rotation drive support 120 includes a recess or slot 122 formed in it for accommodating a portion of housing rotation drive arrangement 112 as is described in more detail below.

Seated in the drive assembly seat 118 is a wand drive carriage 124 that is formed of a pair of upraised drive carriage support brackets 126, 128 that each includes a flanged base 130, 132 that is anchored to the bottom plate 66 of the pet entertainment device body 32. One of the drive carriage support brackets 128 includes integrally formed wand drive motor mounting flanges 134 that receives, locate and help support an electric wand drive motor 136 that is mounted to bracket 128.

The brackets 126, 128 are generally upright and parallel to one another having a space between them that accommodates a wand drive gear train 138 (FIG. 15) that includes a drive gear 140 coupled to the motor 136 and a partially toothed driven wand holder gear 142 disposed in engagement with the drive gear 140. The wand holder gear 142 includes an integrally formed outwardly extending wand arm 144 that includes a socket 146 formed in it that enables one end of the wand 50 to be inserted and retained therein. In one embodiment, the wand 50 can be releasably inserted and retained therein.

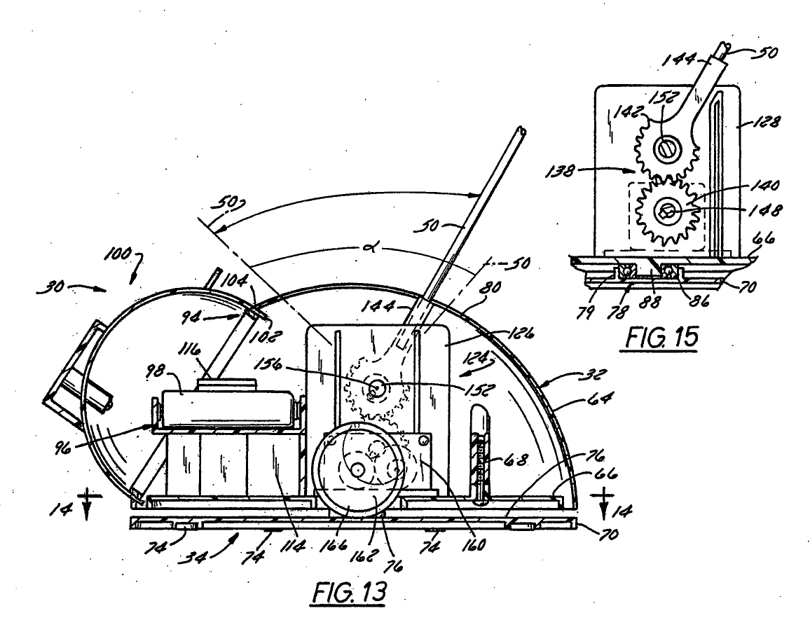

The drive gear 140 is rotatively carried by a drive coupling shaft 148 that can extend through a bore in each bracket 126, 128, such as bore 149, and which has a keyed socket that receives a complementarily shaped rotary output shaft 150 of the wand drive motor 136. The wand holder gear 142 is rotatively carried by a pivot shaft 152 that is received in another bore 154 in each bracket 126, 128. When the wand drive motor shaft 150 is rotated by the motor 136 in one direction, it causes the drive gear 140 to rotate substantially in unison therewith. As the drive gear 140 rotates, engagement between it and the wand holder gear 142 causes the wand 50 to rotate, pivot or whip about a generally transversely second axis of rotation 156 (FIG. 13) in an opposite direction about pivot shaft 152. Of course, when the direction of the wand drive motor shaft 150 is reversed, the direction of wand movement also reverses. As such, bidirectional wand movement is achieved with the wand drive arrangement 110.

The housing rotation drive arrangement 112 includes a second electric drive motor 158 coupled to a drivetrain 160 having an output shaft to which a housing rotation drive roller 162 is attached. The drivetrain 160 seats in the housing rotation drive support 120 in the manner depicted in FIG. 12 helping to anchor the drivetrain 160 to the bottom plate 66 as well as to support the drivetrain 160 during rotation of the housing 32 relative to the base 34. In a preferred embodiment, the drivetrain 160 includes a plurality of gears (not shown) in operable cooperation with an output shaft of the housing rotation drive motor 158 with the output shaft 159 of the drivetrain 160 rotatively coupled to the drive roller 162, which is in turn disposed in contact with the top surface of the base plate 70.

As is shown in FIGS. 12-14, the drive roller 162 is a round wheel, a portion of which extends though a clearance recess 164 (FIG. 14) formed in bottom plate 66 such that it contacts the top surface 76 of the base plate 70. The roller 162 can include an exterior 166, such as a casing or sleeve, composed of a material, such as rubber or the like, that facilitates frictional engagement between it and the top surface 76 of the base plate 70. During operation, rotation of the output shaft of drive motor 158 causes the drive roller 162 to rotate against the base plate 70 thereby turning the bottom plate 66, and hence the housing 64, about vertically extending rotational axis 84.

Also carried by the bottom plate 66 of the pet entertainment device body 32 and disposed within the housing 64 is an onboard controller 168 that is electrically connected to batteries 98, the wand drive motor 136 and the housing rotation drive motor 158 selectively powering each motor 136 and 158 in response to control signals wirelessly received from the remote 38. In the preferred embodiment shown in FIGS. 12 and 14, the controller 168 is a circuit board 170 to which one or more electrical components are attached that are configured to enable wireless signals received from the remote 38 to energize the desired corresponding motor 136 and/or 158 to move the wand 50 and/or rotate the housing 32 in response to manipulation of one or both controls 42, 44 of the remote 38. The controller 168 can include an onboard antenna or can be connected to an antenna that facilitates wireless linking with the remote 38.

In a method of operation, a user can manipulate one control 44 of the remote 38 to cause the wand 50 to move in a corresponding direction about generally transversely extending axis 156 (FIG. 13), e.g. first degree of freedom, to entice a pet, such as a cat, to want to interact with a plaything, e.g., plaything 52, attached to the wand 50. Where the pet is a cat, such as a domestic or house cat, the combination of the wand motion with the movement of a plaything attached to the wand 50 stimulates the hunting instinct of the cat causing it to try to capture the plaything. Because the user remotely controls back and forth motion of the wand 50 from a distance while being able to watch interaction of the cat with the pet entertainment device, the user can change the direction of the wand 50, accelerate motion of the wand 50, or stop the wand 50 as desired in an effort to optimize interaction between the cat and the pet entertainment device 30.

For example, the user can manipulate the wand of movement control 44 of the remote 38 in a manner that keeps the plaything from being captured by the cat or in a manner that allows the cat to at least temporarily capture the plaything. Such a level of interaction between the user and the cat via the remote control of the pet entertainment device 30 is not only fun and entertaining for the user, but is also advantageously fun and entertaining for the cat while also providing the benefit of exercising the cat.

In addition to being able to control movement of the wand 50 relative to the housing 64 by manipulating the corresponding wand movement control 44 of the remote 38, the user can also manipulate the housing rotation control 42 to provide an added level of challenge to the cat. More particularly, because the user is able to remotely cause and control rotation of the housing 64 relative to the base 34 and the floor 46, rotation of the housing about vertical axis 84 also rotates the wand about axis 84, e.g. second degree of freedom, particularly when the wand 50 is disposed off center from the axis of housing rotation 84.

As a result, a user holding and manipulating the remote 38 can visually observe the cat and move the wand 50 by causing it to whip it back and forth relative to the housing 64 and/or by causing the wand 50 to rotate by rotating the housing 64 in a manner that provides a level of interaction between the user and the cat believed not heretofore seen. This is because the wand 50 can be moved by itself, the housing 64 can be rotated by itself which can also displace the wand 50, and/or movement of both the wand 50 and the housing 64 can be simultaneously controlled by the user. As a result of the user being able to control wand movement along two degrees of freedom, cat-user interaction is heightened along with arousal of the hunting instinct of the cat. Play of the cat is prolonged and the exercise value is advantageously increased.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A pet entertainment device comprising a body from which a pet plaything extends outwardly wherein the body is movable relative to a surface upon which the body is supported, wherein the pet plaything is movable relative to the body, and wherein a user controls body movement and pet plaything movement.

2. The pet entertainment device of claim 1 further comprising a base that carries the body wherein the base rests on the support surface and the body is movable relative to the base.

3. The pet entertainment device of claim 2 wherein the base comprises a base plate that immovably rests on the support surface and wherein the body comprises a housing that has a rotatable plate that is rotatively carried by the base plate enabling relative rotation therebetween.

4. The pet entertainment device of claim 3 wherein one of the base plate and rotatable plate comprises a pivot and the other one of the base plate and rotatable plate comprises a pivot receiver that receives the pivot such that cooperation therebetween enables relative rotation therebetween.

5. The pet entertainment device of claim 2 further comprising a plaything carrier that carriers the plaything and a prime mover in operable cooperation with the plaything carrier enabling movement of the plaything relative to the base and the body.

6. The pet entertainment device of claim 5 wherein the plaything carrier comprises a pedestal and a plaything holder pivotally carried by the pedestal and wherein the prime mover comprises an electric motor in operable cooperation with the plaything holder enabling back and forth movement thereof.

7. The pet entertainment device of claim 6 further comprising a gear train operatively coupling the electric motor to the plaything holder.

8. The pet entertainment device of claim 7 wherein the plaything holder comprises a tubular plaything receiving socket and an integral gear and wherein the gear train comprises a gear coupled to an output shaft of the electric motor.

9. The pet entertainment device of claim 7 wherein the pedestal comprises a motor holder to which the electric motor is attached.

10. The pet entertainment device of claim 7 wherein the plaything holder comprises a gear pivotally connected to the pedestal and further comprising a coupling gear pivotally connected to the pedestal and connected to an output shaft of the motor.

11. The pet entertainment device of claim 1 further comprising a user manipulable remote control enabling user control of body movement and pet plaything movement.

12. The pet entertainment device of claim 11 wherein the remote control has a first control enabling user control of body movement and a second control enabling user control of plaything movement.

13. The pet entertainment device of claim 1 further comprising a base that carries the body and further comprising a prime mover disposed interiorly of the body that cooperates with the base enabling movement of the body relative to the support surface.

14. The pet entertainment device of claim 13 wherein the base comprises a base plate that immovably rests on the support surface, wherein the body comprises a housing that is rotatively carried by the base plate.

15. The pet entertainment device of claim 14 wherein the prime mover comprises an electric motor disposed within the housing that is coupled to the base plate by a drive train.

16. The pet entertainment device of claim 16 further comprising a rotatable plate that supports the housing, wherein the motor is carried by the rotatable plate and wherein the drivetrain comprises a wheel driven by the electric motor that cooperates with the base plate enabling relative rotation between the rotatable plate and the base plate.

17. The pet entertainment device of claim 1 further comprising a remote having a first user manipulable control enabling a user to remotely control movement of the pet plaything along a first degree of freedom and a second user manipulable control enabling a user to remotely control movement of the pet plaything along a second degree of freedom.

18. The pet entertainment device of claim 17 wherein user manipulation of the first control causes movement of the plaything about a first axis and wherein user manipulation of the second control causes movement of the plaything about a second axis.

19. The pet entertainment device of 18 wherein one of the first axis and the second axis comprises a generally transversely extending axis and the other one of the first axis and the second axis comprises a generally vertically extending axis.

20. A pet entertainment device comprising:
a body;
a base carrying the body enabling relative rotation therebetween;
a pet plaything or attractant carried by the body that is movable and having a plurality of degrees of freedom of movement; and
a remote control having a first user manipulable control controlling movement of the pet plaything or attractant along a first degree of freedom of movement and a second user manipulable control controlling movement of the pet plaything or attractant along a second degree of freedom of movement.

21. The pet entertainment device of claim 20 comprising a drive in operable cooperation with the pet plaything or attractant enabling movement of the plaything in response to manipulation of one of the first and second controls of the remote.

22. The pet entertainment device of claim 20 comprising a drive in operable cooperation with the pet plaything or attractant enabling movement of the plaything in response to manipulation of the other one of the first and second controls of the remote.

23. The pet entertainment device of claim 20 comprising (a) a first drive in operable cooperation with the pet plaything or attractant enabling movement of the plaything in response to manipulation of one of the first and second controls of the remote and (b) a second drive in operable cooperation with the pet plaything or attractant enabling movement of the plaything in response to manipulation of the other one of the first and second controls of the remote.

24. The pet entertainment device of claim 23 wherein the first drive is constructed and arranged to displace the pet plaything or attractant relative to a first axis and the second drive is constructed and arranged to displace the pet plaything or attractant relative to a second axis.

25. The pet entertainment device of claim 24 wherein the first axis is an axis of rotation that extends generally transversely relative to at least one of the base and the body and the second axis is an axis of rotation that extends generally vertically relative to at least one of the base and the body.

26. The pet entertainment device of claim 23 wherein the first drive comprises an electric motor in operable cooperation with a movable wand holder that receives a wand that carries the pet plaything or attractant enabling movement of the pet plaything or attractant in a first direction.

27. The pet entertainment device of claim 23 wherein the second drive comprises an electric motor in operable cooperation with the body and base enabling movement of the pet plaything or attractant in a first direction.

28. The pet entertainment device of claim 23 wherein the second drive comprises an electric motor in operable cooperation with the body and base enabling relative rotation therebetween.

29. The pet entertainment device of claim 23 wherein the first drive comprises a first electric motor in operable cooperation with a movable wand holder that receives a wand that carries the pet plaything or attractant enabling movement of the wand and pet plaything or attractant in a first direction and wherein the second drive comprises a second electric motor in operable cooperation with the body and base enabling relative rotation therebetween.

30. The pet entertainment device of claim 29 further comprising a drive gear driven by the first electric motor that operatively cooperates with the movable wand holder.

31. The pet entertainment device of claim 30 wherein the wand holder comprises a driven gear having a wand holding arm extending outwardly therefrom with the driven gear disposed in engagement with the drive gear.

32. The pet entertainment device of claim 29 wherein the second motor is carried by the housing and is rotatively coupled by a roller to the base such that second motor rotation of the roller causes relative rotation between the housing and the base.

33. A pet entertainment device comprising:
a base disposed on a support surface;
a body rotatively carried by the base and that carries a pet plaything or attractant enabling movement of the pet plaything or attractant relative to the body.

34. The pet entertainment device of claim 33 further comprising a controller carried by one of the base in the body and a remote wirelessly linked to the controller.

35. The pet entertainment device of claim 34 wherein the remote has a first control user manipulation of which controls relative rotation between the base and the body and has a second control user manipulation of which controls movement of the pet plaything or attractant relative to at least one of the base in the body.

36. The pet entertainment device of claim 35 wherein the base is immovably disposed on the support surface.

37. A pet entertainment device comprising:
a base disposed on a support surface;
a body rotatively carried by the base and that carries a pet plaything or attractant enabling movement of the pet plaything or attractant relative to the body;
a first drive in operable cooperation with the base in the body enabling rotation of one of the base and the body relative to the other one of the base and the body;
a second drive in operable cooperation with the base and the pet plaything or attractant enabling movement of the plaything or attractant relative to the body.

38. The pet entertainment device of claim 37 wherein the first drive comprises a first electric motor that drives a roller or a wheel disposed in communication with one of the base and the body causing relative rotation therebetween when the first electric motor is energized and wherein the second drive comprises a second electric motor coupled by a drive gear to a wand holder carrying an elongate wand that carries the pet plaything or attractant with the wand holder comprising a driven gear having a wand arm extending outwardly therefrom.
